(19) United States
(12) Patent Application Publication
(10) Pub. No.: US 2006/0277181 A1
(43) Pub. Date: Dec. 7, 2006

(54) Content data scheduling using schedule data transmitted via a mobile communication network

(75) Inventors: Stephen Temple, Surrey (GB); Michael Walker, Berkshire (GB); Trevor Michael Gill, Reading (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Vodafone House, The Connection, Berkshire (GB)

(21) Appl. No.: 10/568,551

(22) PCT Filed: Jul. 26, 2005
(86) PCT No.: PCT/GB04/03240

§ 371 Date: Aug. 30, 2006

(30) Foreign Application Priority Data
Aug. 20, 2003 (GB) 0319578.1

(51) Int. Cl. G06F 17/30

(52) U.S. Cl. 707/9

(57) ABSTRACT

For two-letter codes and other abbreviations, refer to the “Guidance Notes on Codes and Abbreviations” appearing at the beginning of each regular issue of the PCT Gazette.

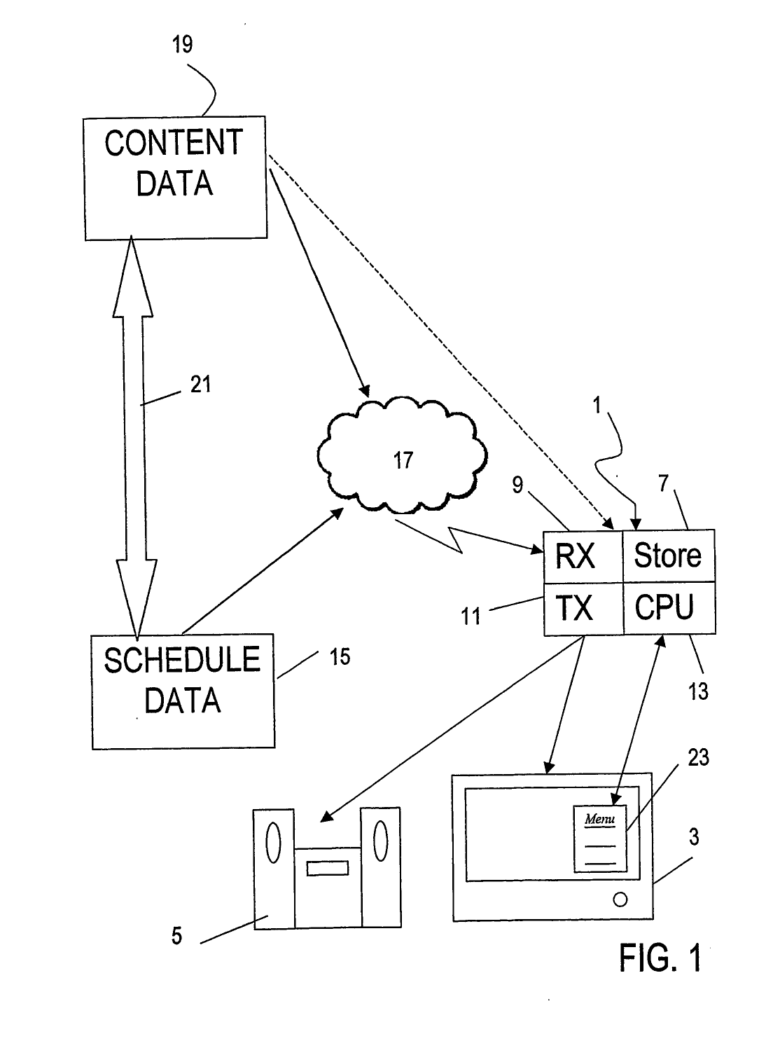

### BACKGROUND OF THE INVENTION

The present invention relates to data distribution, and more particularly to a method of making content data available to the user, a method of controlling access to content data stored on a storage terminal, a mobile telecommunications network and a storage terminal for storing content data, with particular application to (but not limited to) controlling the scheduling of distribution of content data to a user terminal using a mobile telecommunications network.

Television and radio services generally transmit their programme content in real time to user terminals (television sets and radios) by wireless transmission or via a cable connection. Although the programme content is transmitted in real time, much of the programme content is pre-recorded, and only a small proportion of the programme content, such as news and traffic bulletins, is transmitted “live”. The consequence of this is that, for example, a day's television programming requires the transmission of a very large amount of data. The bandwidth available for transmission of the programming content results in there being a limited number of programming channels available, the content of which cannot be personalised for each user.

### SUMMARY OF THE INVENTION

According to a first aspect of the present invention, there is provided a method of making content data available to a user, the method including storing the content data on a storage terminal; transmitting schedule data to the storage terminal via a mobile telecommunications network; receiving the schedule data at the storage terminal; and controlling the transmission of selected content data to a user terminal in accordance with instructions derived from the schedule data so that the selected content data is made available for use by the user terminal.

According to a second aspect of the present invention, there is provided a method of controlling access to content data stored on a storage terminal, including transmitting schedule data to the storage terminal via a mobile telecommunications network; receiving the schedule data at the storage terminal; and controlling the transmission of selected content data to a user terminal in accordance with instructions derived from the schedule data so that the selected content data is made available for use by the user terminal.

According to a third aspect of the present invention, there is provided a mobile telecommunications network including means operable to generate schedule data for transmission over the mobile telecommunications network to a storage terminal on which content data is stored, the schedule data controlling the transmission of selected content data to a user terminal in accordance with instructions derived from the schedule data so that selected content data is made available for use by the user terminal.

According to a fourth aspect of the present invention, there is provided a storage terminal for storing content data, the storage terminal including means for receiving schedule data via a mobile telecommunications network; and means for controlling the transmission of selected content data to a user terminal in accordance with instructions derived from the schedule data so that the selected content data is made available for use by the user terminal.

### BRIEF DESCRIPTION OF THE DRAWINGS

For a better understanding of the present invention, a method of making content data available to a user, a method of controlling access to content data stored in a storage terminal, a mobile telecommunications network and a storage terminal for storing content data, embodying the invention, will now be described byway of example, with reference to the accompanying drawing which shows schematically the components of the system of the embodiment and the data exchanges occurring between those components.

### MODE OF CARRYING OUT THE INVENTION

In accordance with the embodiment, a user is provided with a storage terminal 1. The storage terminal is coupled to the user's television monitor 3 and/or audio system 5. The connection between the storage terminal 1 and the television monitor 3/audio system 5 may be by a conventional cable connection or by a wireless connection (such as Bluetooth RTM). The storage terminal 1 provides video and/or audio data to the television monitor 3/audio system 5 in a similar manner to a so-called “set-top box” provided to subscribers to cable or satellite television services. However, in accordance with the present embodiment, the arrangements for transmitting programming content (hereinafter referred to as “content data”) to the storage terminal 1 are different.

Before these arrangements are described, it should be appreciated that, although the television monitor 3 and audio system 5 (these being “user terminals”) are shown in the Figure as being separate components from the storage terminal 1, the user terminal and the storage terminal could be a single component, integrating the functions of the storage terminal, television monitor and audio system.

The storage terminal 1 includes a content data store 7, a receiver module 9, a transmitter module 11 for transmitting content data to the television monitor 3/audio system 5, and a processor 13. As discussed above, much of the programming content transmitted in real time on conventional television and radio networks comprises pre-recorded material. According to the present embodiment, a large amount of programming content (content data) is pre-stored in the storage module 7 as part of the manufacturing and configuration process of the storage terminal 1. The content data is stored on the storage module 1 prior to shipment of the storage module to the user [symbol] s premises.

The content data stored in the storage module 7 is not freely accessible on demand by the user. The content data stored on the storage module 7 is encrypted and, in isolation, is of no value to the user.

Access to the content data stored in the storage module 7 is controlled by schedule data by the receiver received from module 9 schedule data provider 15. The schedule data comprises instructions interpretable by the processor 13 of the storage terminal 1 which instructs the retrieval, decryption and transmission (in decrypted form) of selected content data stored in storage module 7 to the television monitor 3/audio system 5 by means of the transmitter module 11.

The schedule data from the schedule data provider 15 is communicated to the receiver module 9 of the storage terminal 1 by means of mobile telecommunications network 17. The schedule data from the schedule data provider is transmitted to the mobile telecommunications network 17, for example, by a fixed (wired) link, such as PSTN. The schedule data is then transmitted by the mobile telecommunications network 17 to the receiver module 9 of the storage terminal 1 wirelessly. For example, the mobile telecommunications network 17 may comprise a cellular telecommunications network such as a GSM or UMTS (3G) network. The receiver module 9 may, for example, comprise a wireless application protocol (WAP) browser for receiving the scheduled data from the schedule data provider 15. The receiver module 9 may be implemented as a mobile terminal physically separate from the other components of the storage module 1. The mobile terminal could be a WAP-enabled mobile telephone. Schedule data received by the mobile telephone is then transmitted to the components of the storage terminal 1 by a cable or wireless (such as Bluetooth) connection. Alternatively, the receiver module 9 may include the necessary components of a mobile telephone to receive data from the mobile telecommunications network 17 independently.

It should be appreciated that it is not essential that content data is pre-stored in storage module 7 prior to distribution of the storage terminal 1 to the user. The content data could be downloaded from a content data provider 19 to the storage module 7 by any suitable means, such as a cable connection, Internet connection or wireless connection (such as microwave radio), as indicated by the dashed arrow. Alternatively, content data can be downloaded from the content data provider 19 via mobile telecommunications network 17.

In a currently preferred embodiment, it is envisaged that a large amount of content data will be pre-stored in the storage module 7 prior to distribution of the storage terminal 1 to the user. However, new content data will be downloaded from the content data provider 19 to the storage module 7 periodically. New content data will be downloaded, for example, when a new programme becomes available (such as when a new movie is released), or when a new music release is made by a recording artist. If these periodic updates of content data are performed via the mobile telecommunications network 17, it is advantageous that these updates are performed at times when it is measured, or it is predicted, that the mobile telecommunications network will have spare capacity. Typically, this will be during the night, when fewer “conventional” mobile telephone calls occur. From the user's point of view the time of transmitting content data is irrelevant (and, indeed, the user may not be aware that the data is being downloaded at all). The user's ability to access the content data is controlled by the schedule data.

As discussed above, the content data itself is encrypted. Decryption is facilitated and controlled by the schedule data. Such an arrangement is advantageous when, for example, a new movie is released. To transmit the new movie to all users on a particular day or time would generate a very high burden on the mobile telecommunications network 17 (or other data transmission medium). However, in accordance with the embodiment, the content data representing the new movie can be transmitted to users over a long period of time, beginning substantially in advance of the official [symbol] release date [symbol] of the movie. The commercial benefit to the distributor of the movie of controlling the release date is not lost because the date on which the movie can be viewed by each user is controlled by the schedule data. Transmitting schedule data from schedule data provider 15 to each user which allows viewing of the new movie by all the users at a particular data and time requires only a small fraction of the network capacity that would be required to transmit the entire movie.

For an arrangement of the type described above, it may be useful to provide the storage terminal 1 with a time indicator that provides an indication of the current time, which is accurate and resistant to unauthorised alteration. Otherwise, a user may be able to alter the time indicator of the storage terminal 1, thereby gaining access to the new movie at a time which is not intended by the distributor. It is therefore advantageous that the time indicator is “trusted” by the distributor of the movie. One way of providing a time indicator of this type is to use a Primary Reference Clock (PRC) based on timing signals received from the Global Positioning System (GPS). Using such a PRC, the mobile telecommunications network can always be sure that all associated terminals (such as receiver module 9) have the correct time and date, and these parameters cannot be changed by the user. Alternatively, the time indicator may be provided by a clock generator or “clock chip” in the storage terminal which is set when the storage terminal 1 is manufactured, and is designed so that the time indicated could not be changed by the user of the storage terminal 1. A facility may be provided for periodically verifying the time output of the clock generator/chip with the time available from a third party (for example, from the mobile telecommunications network 17, in order to ensure accuracy over an extended period). The control of the time of decryption of the content data and transmission to the television monitor 3/audio system 5 maybe controlled in accordance with the method and apparatus disclosed in our co-pending United Kingdom patent application No. 0315133.9 (“Secure Time”), the content of which is hereby incorporated by reference.

In many applications it will be desirable to allow the user to receive real time or “live” programming content at their television monitor 3/audio system 5. This is considered to be particularly appropriate for news information, weather information, traffic news and the like. Such content data will be transmitted by the content data provided in 19 in the same manner as other content data downloads described above. However, such content data includes a flag to indicate that it is required to be transmitted to the user's television monitor 3/audio system 5 immediately, or at least within a short period of time. A link 21 between the content data provider 19 and the schedule data provider 15 causes the schedule data provider 15 to transmit to each user's processor 13 (via the receiver module 9) instructions which cause the flagged content data to be decrypted and transmitted by the transmitter module 11 to the user's television monitor 3/audio system 5 immediately or substantially immediately as it is received from the content data provider 19. In addition to schedule data relating to the flagged content data, additional schedule data will be transmitted instructing the interruption and resumption of the programming content which was being transmitted by the transmitter module 11 prior to interruption by the flagged data.

The content data will typically include spoken content. If this spoken content is available in several languages, the language favoured by a particular user can be selected when the user makes their initial subscription to the service, in which case the content data will be transmitted to the storage module 7 in only the selected language. Alternatively, the content data maybe transmitted to the storage module in several available languages. The user selects the presently preferred language, for example by means by a graphical user interface 23 provided on the television monitor 3 under the control of processor 13, and the processor 13 then instructs that the spoken content stored in the storage module 7 having the selected language to be transmitted by the transmitter module 11.

One of the advantages of the present embodiment is that the user may access their content data largely independently of their location. Much of the content data is pre-stored on the storage module 7. Further content data required can be downloaded from content data provider 19 using the mobile telecommunications network 17. The schedule data is also provided by mobile telecommunications network 17. Therefore, the programming content is available to the user whenever the user is in the coverage area of the mobile telecommunications network 17. Further, if the user (and the storage module 1) travel to a location where the user's “home” network 17 does not operate, content data from the content data provider 19, and schedule data from the schedule data provider 15 may be provided by virtue of a “roaming” agreement existing between the home mobile telecommunications network 17 and the mobile telecommunications network available at the location of the storage terminal 1. Some additional costs maybe incurred by virtue of the transmission of data via the roamed network. However, it is envisaged that the majority of the content data will be pre-stored on the storage module 7. Therefore, a user could enjoy the same programming as would have been available in, for example, his home country at little or minimal additional cost.

The processor 13, by means of a graphical user interface 23 provided on the television monitor 3 may allow the user to time shift the programme content. That is, the user may request that the programme content is transmitted earlier or later than indicated by the schedule data from schedule data provider 15. This may be particularly advantageous for subscribers that work unusual hours and are unable to watch the most popular programmes when they are normally transmitted (typically in the evenings). Such users will be able to instruct the processor 13 to delay or advance programming content so that it deviates from the schedule in the schedule data It will also be envisaged that this time shifting will be advantageous when the user is visiting a country in a different time zone from the user's home country.

When the programming content is time shifted, the real time or live content data from the content data provider will not typically be time shifted. When such content data, with the associated flag, as described above, is received, the processor 13 will recognise this and will interrupt the programming being transmitted by the transmitter module 11 so that the real time or live content data can be viewed/heard, and will then resume transmission of the original content data.

The schedule data may be transmitted from the schedule data provider 15 at suitable intervals, such as once a day (24 hour period). Advantageously, the schedule data will be transmitted during the night when the mobile telecommunications network 17 has significant spare capacity. The schedule data may be updated subsequently in order to accommodate changes in circumstances—for example, to allow alteration to programming in the event of an important news story that cannot be adequately covered in the time set aside for news bulletins in the previously transmitted schedule data.

Advertisements may form part of the content data provided by content data provider 19. Typically, television and radio advertisements will be repeated many times. However, each advertisement only needs to be transmitted once to the storage module 7. The advertisement will be repeated under control of the processor 13 in accordance with the schedule data from the schedule data provider 15.

The schedule data may further indicate that particular advertisements are applicable to particular geographical locations. For example, if a user is in London, advertisements relating to entertainment facilities available in London could be transmitted to the television monitor 3/audio system 5, whereas when the user is in Manchester, different advertisements, applicable to that area, will be transmitted. The selection of appropriate advertisements is controlled by the processor 13. The processor 13 maybe provided with information indicating the geographical location of the user by data input using the graphical user interface 23. However, more conveniently, location data is automatically determined and taken into account by the processor 13. For example, the mobile telecommunications network 17 will be aware of the “cell” in which the storage terminal 1 is located. This information is made available to the processor 13 automatically via the receiver module 9. Further, if the user is roaming away from their home network, details relating to the location of that network (and possibly the location within that network) may also be made available to the processor 13 by means of the receiver module 9. It should be appreciated that, in addition to advertisement material being tailored to the user's location, it may also be desired to tailor other programming material to the user's location.

Using instructions contained in the schedule data the processor 13 provides, via the graphical user interface 23 on the television monitor 3, the facility for the user to respond to particular advertisements, for example by using the keypad of a remote control unit for the television monitor 3, to request for information concerning an advertised product or to purchase that product. The request for information or to purchase a product is then transmitted by the receiver means 9 of the storage module 1 (or the associated mobile telephone) to the mobile telecommunications network 17 and onwardly to an appropriate application service provider (not shown). Any charges associated with this request can be deducted from the user [symbol] s account with the mobile telecommunications network 17. Details of the subscriber (such as their name and address) will be held by the mobile telecommunications network 17 and can be transmitted to the advertiser to allow delivery of the requested information product.

Although what has been described above is an arrangement which can provide programming content to a user in a similar manner to one or more conventional television channels (that is, providing generally the same programming content to all users), the system may be configured to allow each user to have made available to them programming content in which they are likely to have a particular interest. For example, when initially subscribing to the service, details of the user's interests will be noted, and programmes likely to be of interest will be pre-stored on the storage module 7. Of course, further content data can be subsequently provided by content data provider 19 as and when further programming is available which relates to the stated interests and/or when the user [symbol] s interests change. Schedule data provider 15 may then schedule a succession of programmes for particular subscriber interest groups—for example, history, sport, etc. Each user may be allowed freedom to deviate from the schedule data provided by the schedule data provider 15.

The programming content distribution system described offers several advantages.

The quality of the content data can be enhanced because it does not generally have to be transmitted in real time. Therefore, a higher quality picture and/or sound data may be transmitted than would be feasible if that video/audio information was transmitted in real time. Further, because the content data (or at least a substantial proportion of the content data) is pre-stored or transmitted significantly before the content data is to be accessed by the user, and also because the schedule data is transmitted in advance of the commencement of transmission to the user of the programming to which the schedule relates, the content data can be viewed by the user even when no or only poor radio coverage is available, such as when travelling through a tunnel.

Because the content data is stored on the storage module 7, the user may be permitted, using the graphical user interface 23 on the television monitor 3, to request that certain content data is repeated. Of course, for some content data (such as a recently released movie or a newly released song), the repetition of this content data may be provided only in exchange for a charge being made to the user (for example in the manner described above).

Content data maybe provided for storage on the storage module 7 of each user's storage terminal free of charge. It may be difficult or impossible to prevent this distributed content data being copied and onwardly transmitted to third parties. However, the third parties will not be able to make use of the content as it is encrypted form at this stage. As discussed above, the content data can only be decrypted on receipt of appropriate decryption data contained in the schedule data received from schedule data provider 15. The schedule data provider 15 is therefore acting as a digital rights management (DRM) broker. The schedule data transmitted by the schedule data provider includes licence information and a content data decryption key to allow particular content data to be accessed under the predetermined conditions. The licence information might, for example, indicate that the content data may be viewed repeatedly by the user without any restriction or charge. Alternatively, the licence might indicate that the content data can be accessed once, and that a further licence is required to access the content again. For example, when a newly released song is transmitted to the user on a music “channel”, the song will be reproduced by the user's audio system 5 at a time in accordance with the schedule data from the schedule data provider 15 without requiring any special payment (in a manner analogous to the song being played on a conventional radio station). The licence information associated with that particular content data (and contained in the schedule data) may include instructions to the processor 13 to offer the user, via the graphical user interface 23 on the television monitor 3, the option to purchase “rights” to the content data. For example, the user be able to play the song a further time for one particular level of payment, or may purchase rights to replay the song an unlimited number of times on payment of a second level of fees. These fees may be conveniently collected from the user's account with the mobile telecommunications network 17.

Steps to protect the content data stored on the storage terminal 1 may be taken as described in the Applicant's patent publication GB 2387505 (“DRM SIM”), the content of which is hereby incorporated by reference.

1. A method of making content data (19) available to a user, the method including storing the content data on a storage terminal (7); transmitting schedule data (15) to the storage terminal (7) via a mobile telecommunications network (17); receiving the schedule data (15) at the storage terminal (7); and controlling the transmission of selected content data (19) to a user terminal (3,5) in accordance with instructions derived from the schedule data (15) so that the selected content data is made available for use by the user terminal (3,5).

2. The method of claim 1, wherein at least some of the content data (19) is stored on the storage terminal (7) by transmitting the content data (19) over the mobile telecommunications network (17).

3. The method of claim 2, wherein the content data (19) is transmitted to the storage module (7) at a time selected to coincide with a time when network use (17) is or is expected to be relatively low.

4. The method of claim 1,2 or 3, wherein at least some of the content data is stored on the storage terminal (7) prior to distribution of the storage terminal (7) to the user.

5. The method of any one of the preceding claims, wherein at least some of the content data (19) is stored on the storage (7) terminal by transmitting the content data via the Internet.

6. A method of controlling access to content data stored on a storage terminal (7), including transmitting schedule data (15) to the storage terminal (7) via a mobile telecommunications network (17); receiving the schedule data (15) at the storage terminal (7); and controlling the transmission of selected content data (19) to a user terminal (3,5) in accordance with instructions derived from the schedule data (15) so that the selected content data (19) is made available for use by the user terminal (3,5).

7. A method of any one of the preceding claims, wherein the storage terminal (7) and the user terminal (3,5) comprise a single device.

8. The method of any one of the preceding claims, wherein the schedule data (15) controls the time of transmission of the content data to the user terminal (3,5).

9. The method of claim 8, wherein the time of transmission is controlled such that the content data (19) is made available to the user terminal (3,5) substantially simultaneously with the transmission of that content data (19) to the storage terminal (7) by the mobile telecommunications network (17).

10. The method of any one of the preceding claims, wherein the user of the user terminal (3,5) can select content data (19) to be transmitted to the storage terminal (7) and for the subsequent transmission to the user terminal (3,5).

11. The method of any one of the preceding claims wherein the user of the user terminal (3,5) can adjust the time of transmission of content data from the storage terminal (7) to the user terminal (3,5).

12. The method of any one of the preceding claims, including determining the location of the user terminal (3,5) and transmitting special schedule data (15) and/or content data (19) in dependence upon the determined location.

13. The method of any one of the preceding claims, including enabling the user to respond to the content data (19) via the mobile telecommunications network (17).

14. The method of any one of the preceding claims, including enabling the user to perform a transaction associated with the content data (19).

15. A method of any one of the preceding claims, wherein the content data (19) is stored on the storage terminal (7) is encrypted.

16. The method of claim 15, wherein the schedule data (15) includes decryption data for use in decrypting the encrypted content data (19).

17. A mobile telecommunications network including means operable to generate schedule data (15) for transmission over the mobile telecommunications network to a storage terminal (7) on which content data is stored, the schedule data (15) controlling the transmission of selected content data (19) to a user terminal (3,5) in accordance with instructions derived from the schedule data (15) so that selected content data (19) is made available for use by the user terminal (3,5).

18. The network of claim 17, including means operable to transmit the content data (19) to the storage terminal (7).

19. The network of claim 18, including means for receiving a request for particular content data from a user, and means for transmitting that content data (19) to the storage terminal (7) for subsequent transmission to the user terminal (3,5).

20. The network of claims 17,18 or 19, including means for providing an indication of the location of the storage terminal (7) within the network, and means for altering the schedule data (15) for transmission to the storage module in dependence upon that location indication.

21. The network of any one of claims 17 to 20, including means for receiving instructions derived from the user terminal in response to the content data (19).

22. The network of any one of claims 17 to 21, including means for enabling a transaction associated with the content data (19) to be performed.

23. The network of any one of claims 17 to 22, wherein the network is a GSM or UMTS mobile telecommunications network.

24. A storage terminal (7) for storing content data, the storage terminal (7) including means for receiving schedule data (15) via a mobile telecommunications network (17); and means (13) for controlling the transmission of selected content data to a user terminal (3,5) in accordance with instructions derived from the schedule data (15) so that the selected content data (19) is made available for use by the user terminal (3,5).

25. The storage terminal of claim 24, wherein the receiving means (9) comprises an interface for receiving the schedule data (15) from a mobile terminal, which mobile terminal is operable to receive schedule data (15) from the mobile telecommunications network (17).

26. The storage terminal of claim 24, wherein the receiving means (9) comprises a transceiver connectable to the mobile telecommunications network (17) for receiving schedule data from the mobile telecommunications network (17).

27. The storage terminal of claim 24, 25 or 26, including means for receiving content data (19) to be stored over the mobile telecommunications network (17).

28. The storage terminal of any one of claims 24 to 27, including means for receiving content data (19) to be stored by means of the Internet.

29. The storage terminal of any one of claims 24 to 28, including means for transmitting (11) content data (19) to the user terminal (3,5) substantially simultaneously with transmission of that content data (19) to the storage terminal (7) by the mobile telecommunications network (17).

30. The storage terminal of any one of claims 24 to 29, including means for receiving (13) instructions from the user terminal (3,5) which are indicative of a selection of content data required, and means for transmitting a signal indicative of this selection to a content data provider.

31. The storage terminal of any one of claims 24 to 30, including means for adjusting the transmission time of content data (19) from the storage terminal (7) to the user terminal (3,5).

32. The storage terminal of any one of claims 24 to 31, including means for determining the location of the storage terminal (7) and for varying the content data (19) transmitted to the user terminal in dependence upon that location determination.

33. The storage terminal of any one of claims 24 to 32, including means for transmitting a response to the content data (19) from the user terminal via the mobile telecommunications network (17).

34. The storage terminal of any one of claims 24 to 33, including means (13) for enabling a transaction associated with the content data (19) to be performed.

35. The storage terminal of any one of claims 24 to 34, including means (13) for decrypting encrypted content data (19) and transmitted the decrypted content data to the user terminal (3,5).
